(19) United States
(12) Patent Application Publication
(10) Pub. No.: US 2014/0118130 A1
(43) Pub. Date: May 1, 2014

(54) AUTOMOBILE WARNING METHOD AND AUTOMOBILE WARNING SYSTEM UTILIZING THE SAME

(71) Applicant: WISTRON NEWEB CORP., Hsinchu (TW)

(72) Inventors: Tsai Wang CHANG, Hsinchu (TW); Hsin-Lung HSIAO, Hsinchu (TW); I-Shan CHEN, Hsinchu (TW); Cheng-Hsiung HSU, Hsinchu (TW)

(73) Assignee: WISTRON NEWEB CORP., Hsinchu (TW)

(21) Appl. No.: 13/836,989

(22) Filed: Mar. 15, 2013

(30) Foreign Application Priority Data
Oct. 25, 2012 (TW) 101139412

(51) Int. Cl. B60Q 9/00

(52) U.S. Cl. CPC B60Q 9/008
USPC 340/435

(57) ABSTRACT

An automobile warning method and an automobile warning system are provided. The automobile warning method is disclosed, implemented by an automobile warning system on a vehicle, wherein the automobile warning system includes a microwave reflective detection device and a control device, including: emitting, by the microwave reflective detection device, a microwave signal for detecting whether a mobile object is present in a blind spot of the vehicle; and when the presence of the mobile object is detected, changing, by the control device, a state of a controlled device of the vehicle.

This Application claims priority of Taiwan Patent Application No. 101139412, filed on Oct. 25, 2012, and the entirety of which is incorporated by reference herein.

### BACKGROUND OF THE INVENTION

1. Field of the Invention

The present invention relates to an intelligent transport system, and in particular, relates to an automobile warning method and automobile warning system utilizing the same.

2. Description of the Related Art

Increased vehicle accidents have been reported, where a driver of a vehicle opens a vehicle door abruptly, causing an approaching motorbike or car to collide with the opened door, rendering considerably loss of property, and in some cases, life. As IC technology advances, new applications to identify driving hazards for vehicle owners, and enhance driving safety, by monitoring road conditions and providing information about hazardous driving conditions, have been developed.

Conventionally, drivers of vehicles can observe road conditions at the rear of a vehicle via a rearview mirror or side mirror, which may be enlarged for a wider viewing angle, or via an imaging system such as a camera or a distance sensor, thereby detecting objects in blind spots. Nevertheless, false detection may occur during severe weather conditions or for long distances. When a blind spot hazard is identified accurately, the driver is correctly informed, and may act to brake, reduce a speed or observe blind spots before opening a door.

### BRIEF SUMMARY OF THE INVENTION

In one aspect of the invention, an automobile warning method is disclosed, implemented by an automobile warning system on a vehicle, wherein the automobile warning system includes a microwave reflective detection device and a control device, and the automobile warning method comprises: emitting, by the microwave reflective detection device, a microwave signal for detecting whether a mobile object is present in a blind spot of the vehicle; and when the presence of the mobile object is detected, changing, by the control device, a state of a controlled device of the vehicle.

In another aspect of the invention, an automobile warning system is provided, implemented by a vehicle, comprising a microwave reflective detection device and a control device. The microwave reflective detection device is configured to emit a microwave signal for detecting whether a mobile object is present in a blind spot of the vehicle. The control device, coupled to the microwave reflective detection device, is configured to change a state of a controlled device of the vehicle when the presence of the mobile object is detected.

### BRIEF DESCRIPTION OF DRAWINGS

The invention can be more fully understood by reading the subsequent detailed description and examples with references made to the accompanying drawings, wherein:

FIG. 1 shows a vehicle 1 with an automobile warning capability according to an embodiment of the invention;

FIG. 2 is block diagram of an automobile warning system 2 according to an embodiment of the invention;

FIG. 3 illustrates the BSD hazard warning implemented by the automobile warning system 2 of FIG. 2;

FIG. 4 illustrates the DOW hazard warning implemented by the automobile warning system 2 of FIG. 2;

FIG. 5 illustrates the RCTA hazard warning implemented by the automobile warning system 2 of FIG. 2;

FIG. 6 is a flowchart of an automobile warning method 6 according to an embodiment of the invention; and

FIG. 7 is a flowchart of an automobile warning method 7 according to an embodiment of the invention.

### DETAILED DESCRIPTION OF THE INVENTION

Various embodiments illustrate hardware and software implementations for incorporating the functions of Blink Spot Detection (BSD), Door Open Warning (DOW) and Rear Cross Traffic Alert (RCTA), adoptable for various transport vehicles including bikes, cars, trucks and vans.

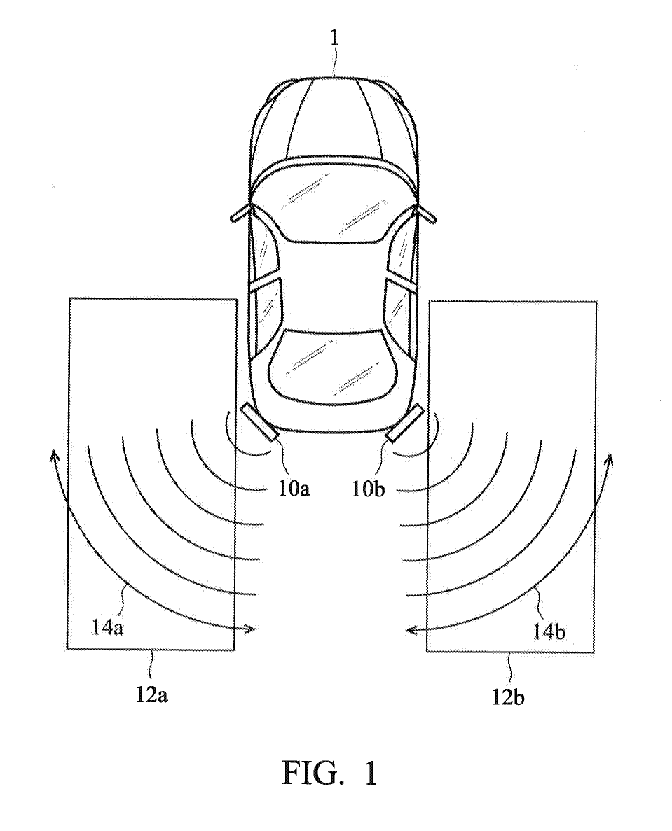

FIG. 1 shows a vehicle 1 with an automobile warning capability according to an embodiment of the invention, identifying driving hazards in an area that cannot be directly observed by a blind spot system, a door open warning system and a rear cross traffic alert system. As shown FIG. 1, the vehicle 1 includes radars 10a and 10b at two sides of a rear part of the vehicle 1, detecting any object present in blind spot areas 12a and 12b for drivers of the vehicle 1. Upon detecting the presence of an object in the blind spot areas 12a or 12b, the vehicle 1 can change a state of a vehicle device, such as a side mirror, an indication light or even an audio alert system, to warn the vehicle driver and passengers of the detected hazardous driving condition.

In some embodiments, the blind spot detection radars 10a and 10b may be installed on a rear bumper of the vehicle 1 for implementing the blind spot detection system, emitting microwave signals at certain microwave frequencies such as 24 GHz or 77 GHz for detecting objects present in the blind spot area of a driver, thereby increasing driving safety for drivers. The blind spot detection radars 10a and 10b can detect or track corresponding reflection signals for identifying any moving object covered in the rear blind spot areas 12a or 12b, such as other vehicles or obstacles. The blind spot detection radars 10a and 10b are different from an image sensor in that the blind spot detection radars 10a and 10b are not affected by various weather conditions such as rains, fogs, snows or dark to render problems in object detection and identification. In certain embodiments, each of the blind spot detection radars 10a and 10b can cover a detection angle coverage of ±90°. Further, each blind spot detection radar can cover a detection coverage of 3×8 meters.

By utilizing applications associated with blind spot detection, the vehicle 1 can provide the function for a door open warning system. When a driver or passenger opens the vehicle door while the vehicle 1 is motionless, the door open warning system detects any approaching motorcycle or car by the blind spot radars 10a and 10b on the vehicle 1, and warns the driver or passenger not to open the door in haste when detecting the approaching motorcycle or car, to prevent the vehicle 1 from accidents with oncoming traffic.

Additionally, when the vehicle 1 reverses to leave a parking space, by utilizing applications associated with blind spot detection, the vehicle 1 can inform the driver of rear traffic conditions, providing the function of a rear cross traffic alert system. When a driver reverses a vehicle 1 in the parking lot, and a fast approaching moves close to the rear part of the vehicle 1, a potential collision hazard may be identified by the rear cross traffic alert system. As a result, an audio alert or an LED warning flash will be generated, reminding the driver of the oncoming traffic at the rear and the potential collision hazard, thereby, enhancing driving safety when driving the vehicle 1 in reverse.

By monitoring according to the embodiments in the invention, the vehicle 1 can employ enhanced software algorithms, in conjunction with associated electronic control devices the existing software, hardware, and computer platforms, combined with an Intelligent Transportation System Dedicated Short Range Communication (ITS DSRC), to provide the functionalities of blind spot detection warning, door open warning, and the rear cross traffic alert systems. By incorporating the various warning systems, a radar can detect lateral and rear traffic information via the hardware and software control mechanisms for the electronic control device, providing warnings via appropriate man-machine interfaces at appropriate timing.

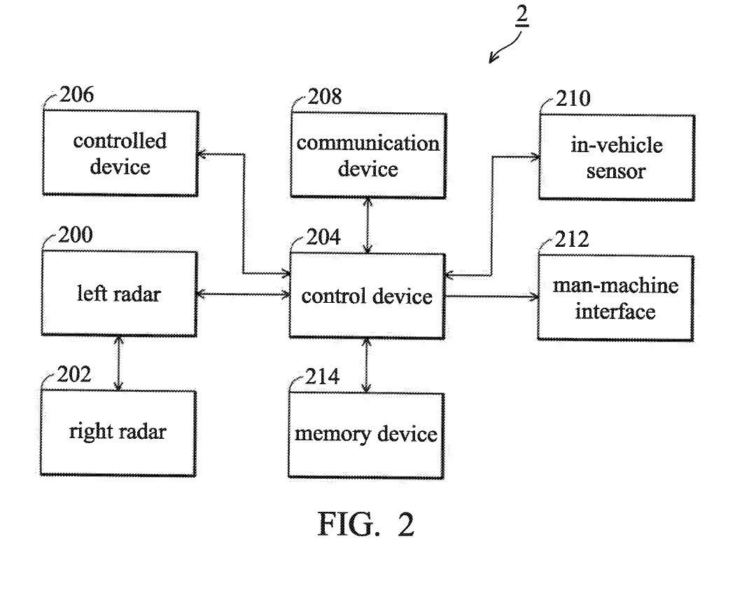

FIG. 2 is block diagram of an automobile warning system 2 according to an embodiment of the invention, implemented by the vehicle 1 in FIG. 1. The automobile warning system 2 of FIG. 2 includes a left radar 200, a right radar 202, a control device 204, a controlled device 206, a communication device 208, a vehicle sensing device 210, a man-machine interface 212 and a memory device 214. The left radar 200, the right radar 202, the controlled device 206, the communication device 208, the vehicle sensing device 210, the man-machine interface 212 and the memory device 214 are coupled to and controlled by the control device 204. The right radar 202 may be coupled to the control device 204 via the left radar 200, or the left radar 200 may be coupled to the control device 204 via the right radar 202, or both the left radar 200 and the right radar 202 arc directly connected to the control device 204.

The left radar 200 and the right radar 202 are the blind spot detection radars 10a and 10b On the vehicle 1 of FIG. 1, detecting the object covered by the blind spot areas 12a and 12b. The detected object may be a moving object, such as another vehicle, a pedestrian, or a pet.

The control device 204 may be implemented by one or more controllers or processors. When detecting a moving object present in the blind spots 12a and 12b, the control device 204 can execute the hardware circuits or software codes to determine whether the moving object is a potential driving hazard. When identifying the potential driving hazard, the control device 204 can change the state of the control device 206 to warn the driver or passenger of the BSD, the DOW or the RCTA hazard.

The controlled device 206 may be a vehicle door, window, buzzer, indication device, vibration se , radio transmitter, seat belt, horn, or any other warning device that can issue warning signals to the driver by changing a state thereof. The communication device 208 may be a circuit compliant with a certain inter-vehicle communication protocol, such as the ITS DSRC protocol. The man-machine interface 212 may be a display screen, an alert indicator or a buzzer. The in-vehicle sensing device 210 may be a sensor capable of sensing the state of the controlled device 206, e.g., sensing whether someone is touching the vehicle door handle from the inside or the outside. The memory device 214 may be a memory storing various information including the vehicle speed, the left and right signaling lights, the yaw rate, the vehicle door state and the vehicle gear.

The state of the controlled device 206 may be changed from the interior of the vehicle by closing or locking up the vehicle doors, retracting or loosening the seat belts, flashing the indication light, displaying on the monitor screen, playing an audio alert by the buzzer, vibrating the vibration seat toward the target hazardous object, or may be changed from the exterior of the vehicle by signaling the signaling light, sounding the vehicle horn, or issuing a hazard warning to the oncoming and nearby vehicles via the ITS DSRC. Further, upon automatically searching for and receiving the hazard warning from a dedicated radio channel, the target vehicle may issue a hazard alert warning, an indication light alert warning, an on-screen alert warning, or an audio alert warning, rendering a full hazard alert system.

In certain embodiments, the driver in the vehicle 1 can configure the control device 212 via the man-machine interface 212 to change the controlled device 206 by the types of the hazardous conditions. For examples, when detecting a BSD hazard, the vehicle 1 may provide the hazard warning by retracting or loosening the seat belt. When detecting a DOW hazard, the vehicle 1 may provide the hazard warning by sounding the buzzer. When detecting an RCTA hazard, the vehicle 1 may provide the hazard warning by vibrating the vibration seat toward the target object.

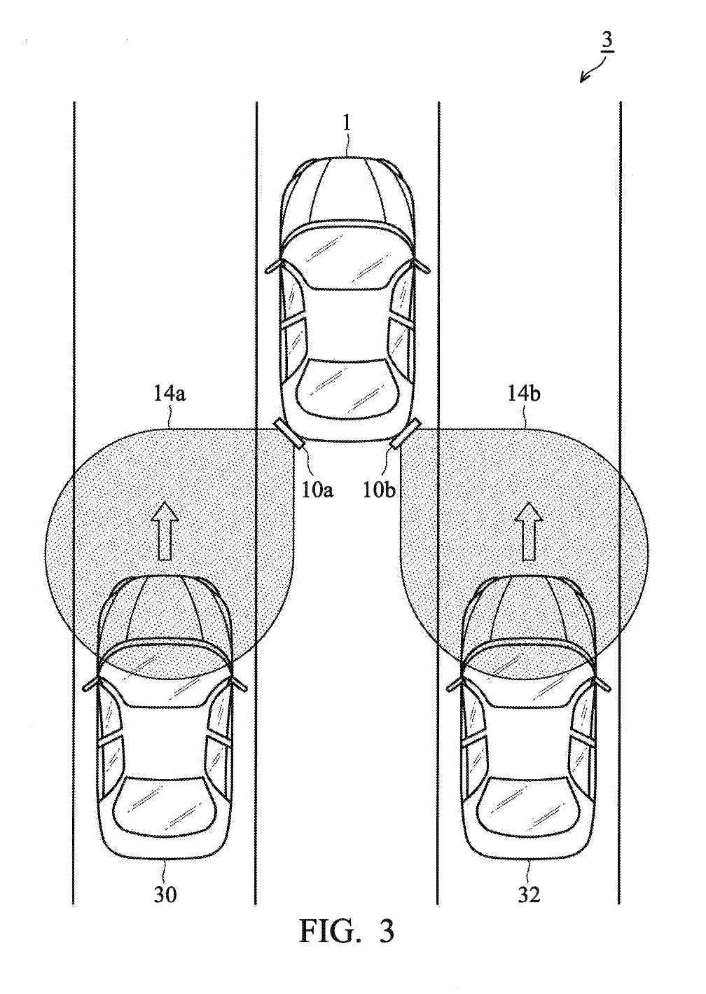

Referring to FIG. 3, FIG. 3 illustrates the BSD hazard warning implemented by the automobile warning system 2 of FIG. 2, incorporated with the automobile warning system 2 of FIG. 2, for explaining the BSD warning method according to an embodiment of the invention.

For the BSD warning system, the vehicle 1 is configured so that when the vehicle is moving forward and the vehicle speed exceeds a first speed, e.g., 10 kilometers per hour, the control device 204 may initiate the blind spot detection radars 10a and 10b for detecting whether a moving object is present in the blind spot areas 12a and 12b. When detecting the moving object 30 or 32, the blind spot detection radars 10a and 10b may generate a detection signal to the control device 204. Subsequently, the control device 204 can determine whether the moving objects 30 or 32 may pose any potential driving hazard based on the detection signal and the information stored in the memory device 214. When a potential driving hazard is determined, the vehicle 1 can change the state of the controlled device 206 or the man-machine interface 212, such as changing the interior of the vehicle 1 by closing or locking up the vehicle doors, tightening or loosening the seat belts, flashing the indication light, displaying on the monitor screen, playing an audio alert by the buzzer, vibrating the vibration seat toward the target hazardous object, while chaning the exterior of the vehicle 1 by signaling the signaling light, or sounding the vehicle horn to remind the driver of the potential driving hazard. In some embodiments, the vehicle 1 can issue driving hazard warning information to the target and nearby vehicles via the ITS DSRC, providing hazard warnings to the surrounding traffic, in particular, to the target vehicle in motion.

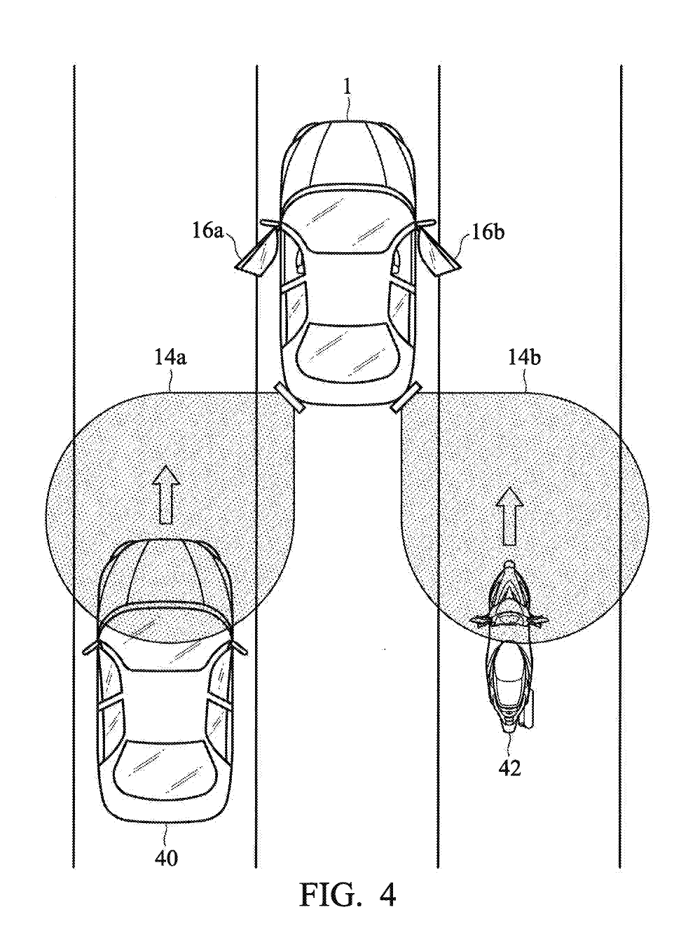

Referring to FIG. 4, FIG. 4 illustrates the DOW hazard warning implemented by the automobile warning system 2 of FIG. 2, for explaining the DOW warning method according to an embodiment of the invention.

For the DOW warning system, the vehicle 1 is configured so that when the vehicle door is opened or when the vehicle sensing device 210 detects a touch on the door handle from the inside or outside of the vehicle 1, the vehicle sensing device 210 can send the detected signal to the control device 204, activating the blind spot detection radars 10a and 10b for detecting whether a moving object is present in the blind spot areas 12a and 12b. When detecting the moving object 40 or 42, the blind spot detection radars 10a and 10b may generate a detection signal to the control device 204. Subsequently, the control device 204 can determine whether the moving objects 40 or 42 may pose any potential driving hazard based on the detection signal and the information stored in the memory device 214. When a potential driving hazard is determined, the vehicle 1 can change the state of the controlled device 206 or the man-machine interface 212, such as changing the interior of the vehicle 1 by closing or locking up the vehicle doors, tightening or loosening the seat belt, flashing the indication light, displaying on the monitor screen, playing an audio alert by the buzzer, vibrating the vibration seat toward the target hazardous object, while changing the exterior of the vehicle 1 by signaling the signaling light, sounding the vehicle horn to remind the driver of the potential driving hazard. Further, the vehicle 1 can issue driving hazard warning information to the target vehicles 40 and 42 via the ITS DSRC, providing a full hazard warning system.

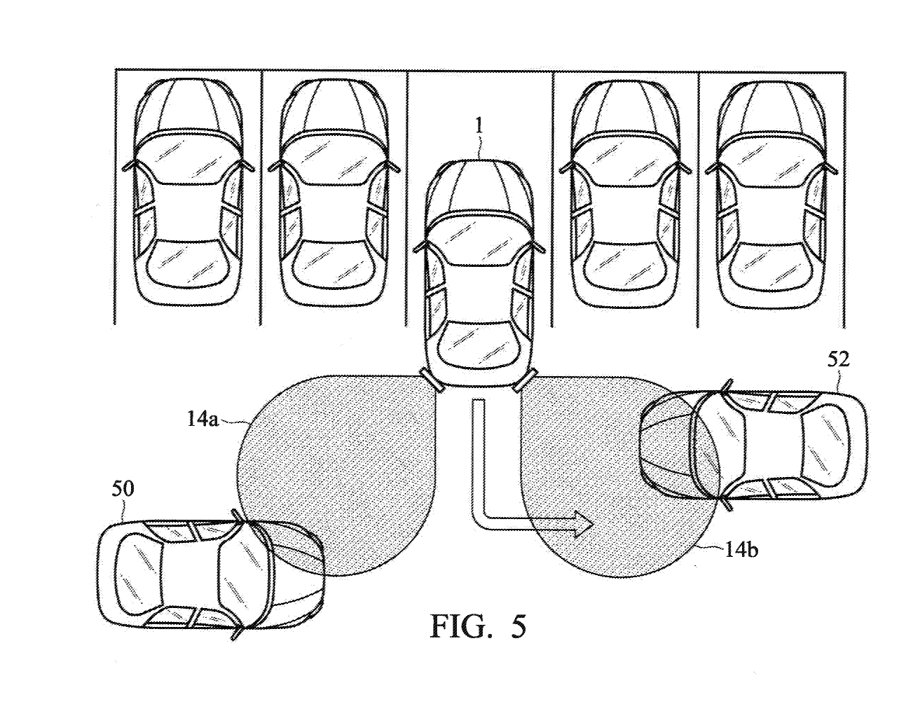

Referring to FIG. 5, FIG. 5 illustrates the RCTA hazard warning implemented by the automobile warning system 2 of FIG. 2, for explaining the RCTA warning method according to an embodiment of the invention.

For the RCTA warning system, the vehicle 1 is configured so that when the vehicle gear is in reverse gear, the control device 204 can activate the blind spot detection radars 10a and 10b, loading a corresponding algorithm for detecting the traffic condition at the rear left and right sides, When determining a target vehicle 50 or 52 is present, the radar 10a or 10b can generate a detection signal to the control device 204. Subsequently, the control device 204 can determine whether the moving objects 40 or 42 may pose any potential driving hazard based on the detection signal and the information stored in the memory device 214. When a potential driving hazard is determined, the vehicle 1 can change the state of the controlled device 206 or the man-machine interface 212, such as changing the interior of the vehicle 1 by closing or locking up the vehicle doors, tightening or loosening the seat belt, flashing the indication light, displaying on the monitor screen, playing an audio alert by the buzzer, vibrating the vibration seat toward the target hazardous object, while changing the exterior of the vehicle 1 by signaling the signaling light, sounding the vehicle horn to remind the driver of the potential driving hazard. Further, the vehicle 1 can issue driving hazard warning information to the target vehicles 40 and 42 via the ITS DSRC, automatically searching for a radio channel for transmitting the hazard warning, thereby generating an indication light warning, an on-screen warning, an audio warning, rendering a complete hazard alert system.

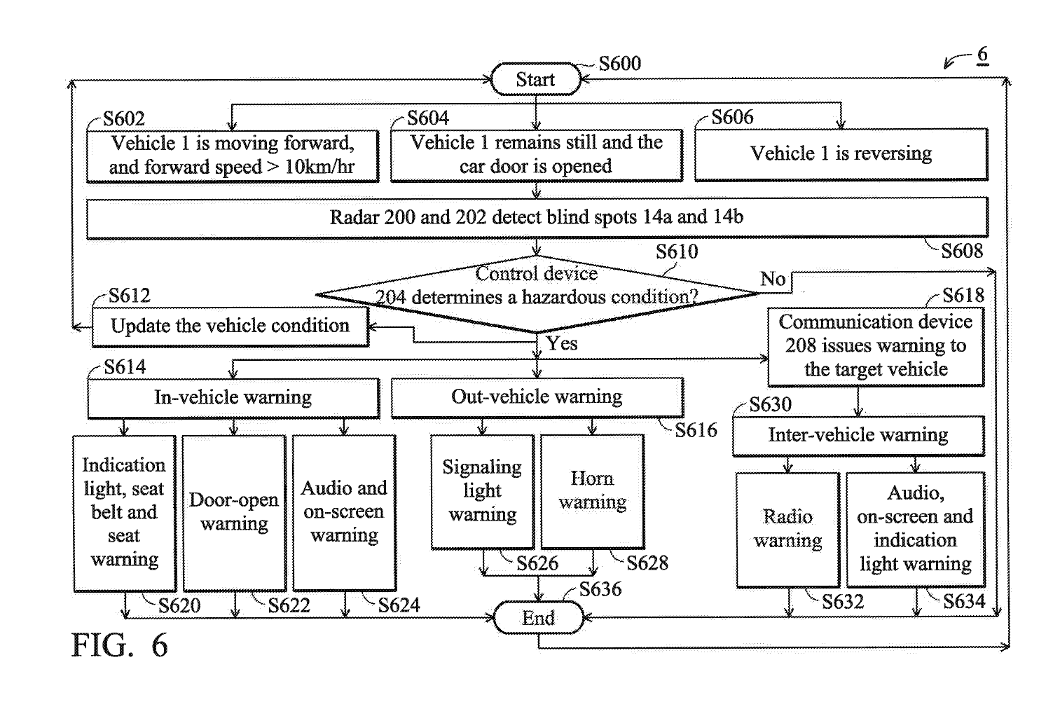

FIG. 6 is a flowchart of an automobile warning method 6 according to an embodiment of the invention, incorporating the automobile warning system 2 of FIG. 2.

Upon startup of the automobile warning method 6, the control device 204 can initialize the other connected devices 200 through 214, and acquire the information of the vehicle gear from the memory device 214 (S600). The control device 204 can determine a subsequent step based on the information on the vehicle gear. For example, the control device 204 can continue to Step S602 when the vehicle gear is in drive gear, to Step S604 when the vehicle gear is in park gear, and to Step S606 when the vehicle gear is in reverse gear.

In Step S602, the control device 204 can determine that the vehicle gear is in drive gear and activate the BSD function. In some embodiments, the control device 204 may further acquire vehicle speed information from the memory device 214, and only activate the blink sport radars 10a and 10b for detecting objects in the blind spot areas 12a and 12b (S608) when the vehicle speed exceeds 10 kilometer per hour.

In Step S604, the control device 204 can determine that the vehicle gear is in park gear and activate the DOW function. The control device 204 can acquire the information of the vehicle door status from the memory device 214 and acquire the detection signal indicating whether someone is touching the vehicle door or the door handle from the vehicle sensing device 210. When the control device 204 determines that the vehicle door status is opened or someone is touching the vehicle door or the door handle, the blind detection radars 10a and 10b can be activated to initiate the DOW procedure (S608).

In Step S606, the control device 204 can determine that the vehicle gear is in park gear, activate the RCTA function, and initiate the blind detection radars 10a and 10b to detect the moving object in the blind spot areas 12a and 12b (S608).

In Step S608, the blind detection radars 10a and 10b can emit the microwave signals for detecting the target object covered in the blind spot areas 12a and 12b. Upon detecting the object, the blind detection radars 10a and 10b can generate and transmit the detection signal to the control device 204. In turn, the control device 204 can determine a hazardous condition based on the detection signal (S610).

The vehicle radars 10a and 10b are configured to detect the target object, and when the radars 10a and 10b or the control device 204 determine that the target object is likely to collide with the vehicle in 4 seconds, a hazardous condition will be determined, and a hazard warning will be issued. In Step S610, the control device 204 can acquire the information of the vehicle speed, the left and right signaling lights or the yaw rate, in conjunction with the detection signal from the blind detection radars 10a and 10b, to determine whether a BSD hazard condition, a DOW hazard condition or an RCTA hazard condition has occurred. For example, when the vehicle gear is in drive gear, the vehicle speed is 15 kilometers per hour and the yaw rate indicates that the vehicle 1 is turning. When the blind spot detection radar 10a detects that a car is moving forward 20 kilometers per hour in the blind spot area 12a, the control device 204 may determine that a BSD hazard condition has occurred and a corresponding hazard warning has to be issued. In other embodiments, when the vehicle gear is in park gear, the vehicle doors are closed and someone is touching the in-vehicle door handle. When the blind spot detection radar 10a detects a car approaching in the blind spot area 12a, the control device 204 may determine that a DOW hazard condition has occurred and a corresponding hazard warning has to be issued. In yet other embodiments, when the vehicle gear is in reverse gear, the vehicle doors are reversing to the right. When the blind spot detection radar 10a detects a car approaching in the blind spot area 12a, the control device 204 may determine that an RCTA hazard condition has occurred and a corresponding hazard warning has to be issued. When the control device 204 determines that no hazardous condition is present, the automobile warning method 6 will be exited (S636). When the control device 204 determines one of the hazardous conditions, a current vehicle condition parameter will be updated and a hazard warning will be issued to the driver or the detected target object. The types of the hazard warnings include a in-vehicle warning (S614), a out-vehicle warning (S616) and a inter-vehicle warning (S618). The control device 204 can employ one or more warning types for alerting the driver and the target vehicle. In some embodiments, the vehicle manufacturers or the driver can configure the warning types for use by the control device 204 upon determining the hazardous condition. The current vehicle condition parameter may be recorded in the memory device 214, and may be one of the normal condition, the BSD hazard condition, the DOW hazard condition or the RCTA hazard condition.

In step S614, when the in-vehicle warning is adopted, the control device 204 can determine one or more types of warnings are to be adopted according to the user configuration. The types of warnings to be selected from include an indication light, seat belt and seat warning (620), a door open warning (S622), and an audio and on-screen warning (S624). When the indication light, seat belt and seat warning is adopted, the control device 204 can control the corresponding indication light to indicate an alert indication, control the seat belt to be loosened or tightened, or control the vibration seat to vibrate toward the detected target vehicle (S620). When the door open warning is adopted, the control device 204 can close or lock the vehicle door (S622). When the audio and on-screen warning is adopted, the control device 204 can control the buzzer to generate an audio alert, or control the monitor to display the on-screen warning (S624).

In Step S616, when the out-vehicle warning is adopted, the control device 204 can determine one or more types of warnings to adopt according to the user configuration. The types of warnings to be selected from include a signaling light warning (S626) and a horn warning (S628). When the signaling light warning is adopted, the control device 204 can control the signaling lights on the exterior of the vehicle 1 to indicate a warning alert (S626). When the horn warning is adopted, the control device 204 can the horn of the vehicle 1 to generate a warning sound (S628).

In Step S618, when the inter-vehicle warning is adopted, the control device 204 can control the communication device 208 to issue warning signals to the surroundings. In some embodiments, the communication device 208 may ? the ITS DSRC to send the warning signals to all surrounding ? or the detected target vehicle. The object or vehicle receiving the warning signal may further produce subsequent warning signals (S630). For example, based on the received warning signal, the target vehicle can produce an alert message by the radio in the target object or vehicle (S632), or produce an alert sound by the buzzer or a warning message on the monitor in the target object or vehicle (S634).

After the warning message is issued, the automobile warning method 6 is completed and exited (S636).

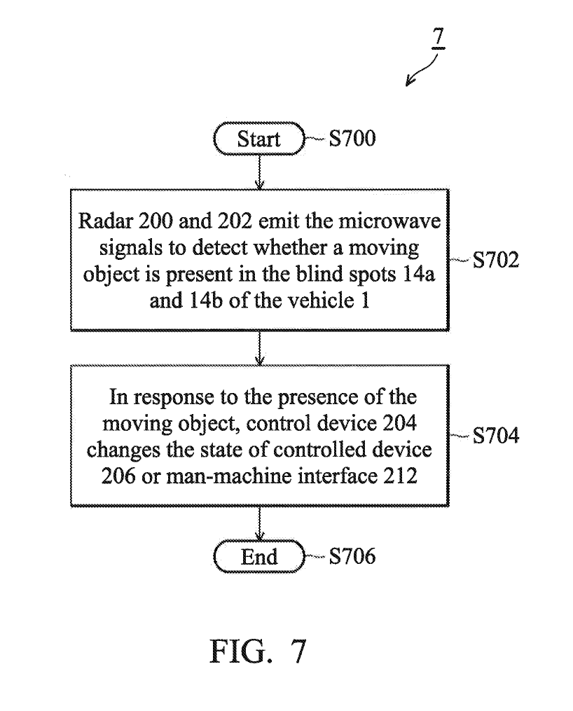

FIG. 7 is a flowchart of an automobile warning method 7 according to an embodiment of the invention, incorporating the automobile warning system 2 of FIG. 2.

Upon startup of the automobile warning method 7, the control device 204 can initialize the other connected devices 200 through 214, and acquire the information of the vehicle gear from the memory device 214 (S700). Based on the information of the vehicle gear, the control device 204 can determine and perform a BSD hazard procedure when the vehicle gear is in drive gear, a DOW hazard procedure when the vehicle gear is in park gear, and a RCTA hazard procedure when the vehicle gear is in reverse gear. The determination of the type of the hazard procedure to be used can be found in the previous descriptions of Steps S602 through S604, thus, details will not be repeated here for brevity. When the control device 204 determines to execute one of the BSD hazard procedure, the DOW hazard procedure and the RCTA hazard procedure, the blind spot detection radars 10a and 10b can be activated for detecting whether a moving object is present in the blind spot areas 12a and 12b (S702). When the blind spot detection radars 10a or 10b detect a moving object in the blind spot areas 12a and 12b, a detection signal is generated and transmitted to the control device 204. In response, the control device 204 can change the controlled device 206 of the vehicle 1 and generate warnings to the driver in the vehicle 1 or the detected target vehicle (S704). The state chage for the controlled device 206 can find references in Steps S614 through S634, details therefor are omitted here for brevity. After the warning message is issued, the automobile warning method 7 is completed and exited (S706).

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine.

The operations and functions of the various logical blocks, modules, and circuits described herein may be implemented in circuit hardware or embedded software codes that can be accessed and executed by a processor.

While the invention has been described by way of example and For the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An automobile warning method, implemented by an automobile warning system on a vehicle, wherein the automobile warning system includes a microwave reflective detection device and a control device, the automobile warning method comprising:
emitting, by the microwave reflective detection device, a microwave signal for detecting whether a mobile object is present in a blind spot of the vehicle; and
when the presence of the mobile object is detected, changing, by the control device, a state of a controlled device of the vehicle.

2. The automobile warning method of claim 1, further comprising:
when the presence of the mobile object is detected, sending, by the control device, a warning signal to the mobile object.

3. The automobile warning method of claim 1, wherein the changing step comprises:
when the presence of the mobile object is detected, determining whether a hazardous condition has occurred based on information of the detected mobile object and the vehicle; and
when the hazardous condition has occurred, changing the state of a controlled device of the vehicle.

4. The automobile warning method of claim 3, wherein the hazardous condition comprises a blind spot hazardous condition, a door open warning hazardous condition and a rear cross hazardous condition.

5. The automobile warning method of claim 1, wherein the emitting the microwave signal step comprises: only when a door of the vehicle senses the input of a touch, emitting the microwave signal for detecting the blind spot by the microwave reflective detection device.

6. The automobile warning method of claim 1, wherein the emitting the microwave signal step comprises:
only when the vehicle is reversing, emitting the microwave signal for detecting the blind spot by the microwave reflective detection device.

7. The automobile warning method of claim 1, wherein the emitting the microwave signal step comprises:
only when the vehicle is moving forward, emitting the microwave signal for detecting the blind spot by the microwave reflective detection device.

8. The automobile warning method of claim 1, wherein the controller device comprises a indicator light, a seat belt, a seat, a monitor, a buzzer, a signal light, a horn and a communication device.

9. An automobile warning system, implemented by a vehicle, comprising:
a microwave reflective detection device, configured to emit a microwave signal for detecting whether a mobile object is present in a blind spot of the vehicle; and
a control device, coupled to the microwave reflective detection device, configured to change a state of a controlled device of the vehicle when the presence of the mobile object is detected.

10. The automobile warning system of claim 9, further comprising a communication device, coupled to the control device, configured to send a warning signal to the mobile object when the presence of the mobile object is detected.

11. The automobile warning system of claim 9, wherein the control device is configured to:
when the presence of the mobile object is detected, determine whether a hazardous condition has occurred based on information of the detected mobile object and the vehicle; and
when the hazardous condition has occurred, change the state of a controlled device of the vehicle.

12. The automobile warning system of claim 11, wherein the hazardous condition comprises a blind spot hazardous condition, a door open warning hazardous condition and a rear cross hazardous condition.

13. The automobile warning system of claim 9, wherein the microwave reflective detection device is configured to emit the microwave signal for detecting the blind spot, only when a door of the vehicle senses the input of a touch.

14. The automobile warning system of claim 9, wherein the microwave reflective detection device is configured to emit the microwave signal for detecting the blind spot, only when the vehicle is reversing.

15. The automobile warning system of claim 9, wherein the microwave reflective detection device is configured to emit the microwave signal for detecting the blind spot, only when the vehicle is moving forward.

16. The automobile warning system of claim 9, wherein the controller device comprises a indicator light, a scat belt, a seat, a monitor, a buzzer, a signal light, a horn and a communication device.
